(19) United States
(12) Patent Application Publication
(10) Pub. No.: US 2017/0099440 A1
(43) Pub. Date: Apr. 6, 2017

(54) External Electronic Viewfinder for SLR Camera

(71) Applicant: Zuoliang WANG, Guangzhou, Guangdong (CN)

(72) Inventor: Zuoliang WANG, Guangzhou, Guangdong (CN)

(21) Appl. No.: 15/126,525

(22) PCT Filed: Jun. 30, 2015
(86) PCT No.: PCT/CN2015/083008

§ 371 Date: Sep. 15, 2016

(30) Foreign Application Priority Data
Jul. 28, 2014 (CN) 201410362528.3

(51) Int. Cl. H04N 5/232; G02B 25/00; G02B 15/14; H04N 5/225; G03B 13/02

(52) U.S. Cl. CPC H04N 5/23293; H04N 5/2254; H04N 5/23296; G03B 13/02; G02B 15/14; G02B 25/001

(57) ABSTRACT

An external electronic viewfinder includes either the lens assembly of the eye-level zoom-in viewfinder (1, 2) and the miniature camera (5), or the lens assembly of the eye-level zoom-in viewfinder (1, 2), the miniature camera (5) and the movable reflector (3). When electronic view-finding is not needed, the viewfinder is used as an optical eye-level zoom-in viewfinder. When it is used as an electronic viewfinder, it is OK to directly move the miniature camera (5) to the optical axis. It is also acceptable to move the movable reflector (3) to the optical axis so that it reflects the images on the miniature camera (5) which then sends them to external display devices (6) via wired or wireless linkage. The photographer can view, compose, focus and remote capture by observing the external display devices.

### FIELD OF TECHNOLOGY

This invention relates to an external electronic viewfinder for an SLR (single-lens reflex) camera, which serves an electronic viewfinder and an eye-level zoom-in viewfinder by fixing a miniature camera or the combination of a miniature camera and a reflector on one side of the lens assembly, a component part of SLR camera. When the electronic viewfinder is not needed, it is used as an optical eye-level zoom-in viewfinder. Otherwise, the miniature camera is moved to the optical axis so that the images can be sent to the external display via wired or wireless linkage in one case. In another case, the reflector is moved to the optical axis so that the images are reflected, through the reflector, on the miniature camera which sends images to external display via wired or wireless linkage. All these enable the photographer to view, compose, focus and shoot by observing the external display. All in all, this invention falls into the category of optics and electron devices.

### BACKGROUND TECHNOLOGY

Viewfinder for SLR camera is an optical viewfinder that directly captures light without error. However, fixed inside the camera, the viewfinder is not user-friendly in low- and high-angle shooting. Therefore, camera manufacturers have made some improvements. For instance, LCD viewfinder is made possible by the use of CMOS while collapsible rotating LCD is worked out and an electronic viewfinder is designed by adding semipermeable membrane to a single electric camera. The latest patent shows that camera manufacturers are going to produce a hybrid optical/electronic viewfinder. Yet, be it LCD viewfinder, electronic viewfinder or hybrid viewfinder, they cannot take over professional photographer's craving for optical viewfinder.

Three types of functioning external viewfinders for SLR camera are as follows:

1. Eye-level zoom-in viewfinder. It zooms in the images by fixing one or more pairs of concave/convex lenses outside the viewfinder.
2. Right-angle zoom-in viewfinder. Through multiple concave/convex lenses and reflector fixed outside the viewfinder, the angle of view can be changed 90 degrees while multi-angle view and image magnification are achieved by rotating the viewfinder.
3. External electronic viewfinder. For instance, my patented invention of “External Viewfinder Accessories for SLR Digital Camera” in 2006 (Patent No.: CN200610085427.1).

This invention integrates the merits of these three types of viewfinders and presents a brand new external electronic viewfinder that combines the eye-level zoom-in viewfinder and the electronic viewfinder.

### TECHNOLOGY PROBLEM

Since the optical viewfinder is fixed inside the camera, the photographer has to press his eyes close to the viewfinder and faces troubles in low- and high-angle shooting. Therefore, LCD viewfinder is made possible by the use of CMOS while collapsible rotating LCD is worked out and an electronic viewfinder is designed by adding semipermeable membrane to a single electric camera. However, these viewfinders are highly dependent on light and bothered by the speed and precision of focusing as a result of focusing by analyzing the reflected light from the scene under the principle of phase difference. Therefore, a built-in optical viewfinder is irreplaceable. This invention is aimed at enabling the photographer to use the built-in optical viewfinder freely and flexibly as an optical eye-level zoom-in viewfinder and an electronic viewfinder as well.

### TECHNOLOGY SOLUTIONS

The technical solution offered by this invention is to design an external electronic viewfinder for an SLR camera. In one case, it consists of one or more pairs of lens assembly that is capable of zooming in the images from the optical viewfinder, a movable or rotating reflector, and a miniature camera. When the movable reflector or rotating reflector is not involved in view-finding and rests on one side of the lens assembly, the external electronic viewfinder is used as an optical eye-level zoom-in viewfinder, and when it is used as an electronic viewfinder, the movable reflector is moved or the rotating reflector is rotated to the optical axis region of the lens assembly so that the reflector reflects the light from the optical viewfinder to the miniature camera which sends images to external display devices via wired or wireless linkage. In another case, it consists of a movable miniature camera and one or more pairs of lens assembly that is capable of zooming in the images of the optical viewfinder. When the movable miniature camera is not involved in view-finding and rests on one side of the lens assembly, the external electronic viewfinder is used as an optical eye-level zoom-in viewfinder, and when it is used as an electronic viewfinder, the miniature camera is moved to the optical axis so that the miniature camera sends images to external display devices via wired or wireless linkage. The described lens assembly capable of zooming in the images of the optical viewfinder consists of an object lens and an eye lens, the movable reflector, rotating reflector or movable miniature camera rests on one side of the object lens. When the movable reflector described rests on one side of the object lens at a 45-degree position, with the object lens, eye lens and the lens assembly of the optical viewfinder on the same optical axis, the external electronic viewfinder is used as an optical eye-level zoom-in viewfinder, and when it is used as an electronic viewfinder, the object lens and the attached movable reflector are moved toward another side, with the object lens out of and the movable reflector into the optical axis region of the lens assembly, to reflect the light from the optical viewfinder to the miniature camera. When the movable reflector described rests on one side of the object lens parallel to its optical axis, with the object lens, eye lens and the lens assembly on the same optical axis, the external electronic viewfinder is used as an optical eye-level zoom-in viewfinder, and when it is used as an electronic viewfinder, the object lens and the attached rotating reflector are rotated on one side of the rotating reflector, with the object lens out of and rotating reflector into the optical axis region of the lens assembly, to reflect the light from the optical viewfinder to the miniature camera. The external electronic viewfinder described is equipped with a built-in LCD, a collapsible and rotatable one, to which the miniature camera sends images via wired linkage and on which the photographer observes them. Images captured by miniature camera can be sent to smart phone, flat panel display or wearable display devices via wireless linkage from the external electronic viewfinder. The described movable reflector, rotating reflector or movable miniature camera can be moved or rotated with manual operation. The external electronic viewfinder described is equipped with a mini motor and a light sensor. When the photographer presses his eyes to the viewfinder, the movable reflector, rotating reflector or movable miniature camera moves away from the optical axis region under the force of the motor, and the electronic viewfinder switches to an optical eye-level zoom-in viewfinder. When the eyes are off the viewfinder, the movable reflector, rotating reflector or movable miniature camera enters the optical axis region under the force of the motor and the electronic viewfinder mode is ready and the LCD displays the images captured by the viewfinder. The external electronic viewfinder described integrates wireless receiver, shutter release and remote control. When the shutter release is linked to the SLR camera, shooting can be taken by the remote control. The miniature camera described uses a prime lens allowing manual focus, a knob for manual focus is set on the viewfinder to form clear images from the focusing screen in case of automatic focusing causing image delay.

### ADVANTAGEOUS EFFECT

This invention enables the photographer to freely and flexibly use the viewfinder as an optical eye-level zoom-in viewfinder as well as an electronic viewfinder. Images are sent to third-party display devices such as LCD, smart phone or wearable display devices like Google Glass via wired or wireless linkage so that the photographer can view, compose and focus by observing the external display devices. This relieves the photographer's eyes when shooting, extends the SLR camera's range of application and makes photographing more flexible and comfortable.

### FIGURE DESCRIPTION

FIG. 1 is the sectional drawing of the 1st embodiment of this invention under user mode 1.

FIG. 2 is the sectional drawing of the 1st embodiment of this invention under user mode 2.

FIG. 3 is the sectional drawing of the 2nd embodiment of this invention under user mode 1.

FIG. 4 is the sectional drawing of the 2nd embodiment of this invention under user mode 2.

FIG. 5 is the vertical view of the 3rd embodiment of this invention under user mode 1.

FIG. 6 is the vertical view of the 3rd embodiment of this invention under user mode 2.

FIG. 7 is the vertical view of the 4th embodiment of this invention under user mode 1.

FIG. 8 is the vertical view of the 4th embodiment of this invention under user mode 2.

FIG. 9 is the vertical view of the 5th embodiment of this invention under user mode 1.

FIG. 10 is the vertical view of the 5th embodiment of this invention under user mode 2.

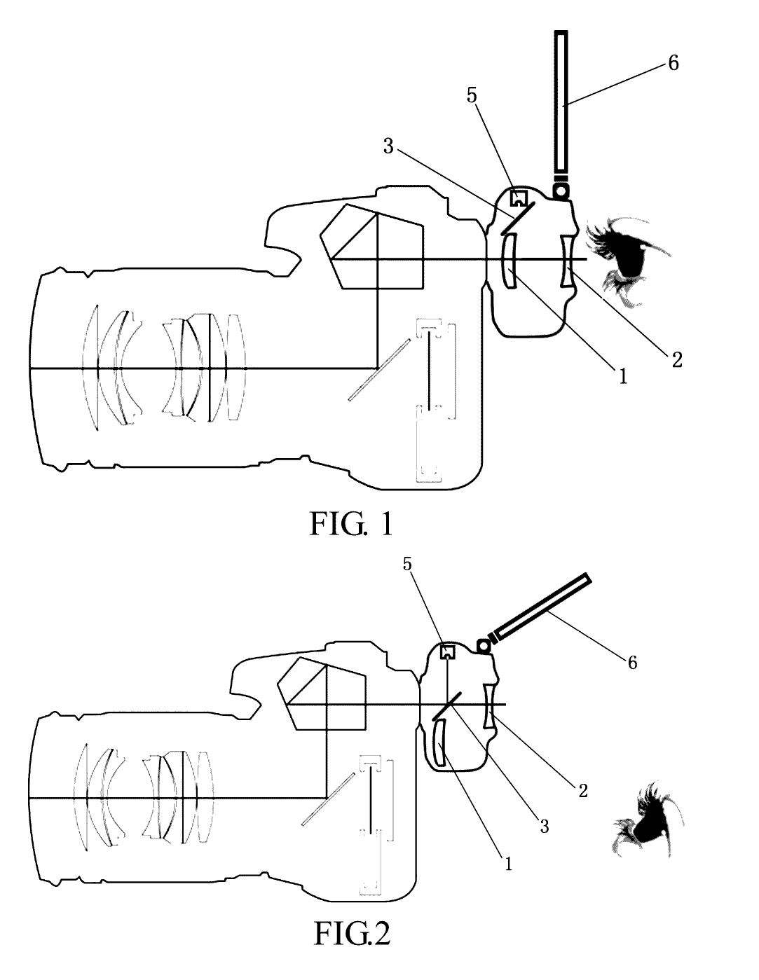

1 refers to the object lens, 2 refers to the eye lens, 3 refers to the movable reflector, 4 refers to the rotating reflector, 5 refers to the miniature camera and 6 refers to the LCD in FIG. 1.

### PREFERRED EMBODIMENT OF THIS INVENTION

The 5th embodiment is preferred in this invention.

### EMBODIMENT OF THIS INVENTION

In practical implementation, the lens assembly of an external electronic viewfinder consists of one or more pairs of object lenses and eye lenses. The combination of an object lens and an eye lens is the simplest solution. To demonstrate the technical solution in a simple manner, as shown in the figures, the lens assembly consists of an object lens and an eye lens.

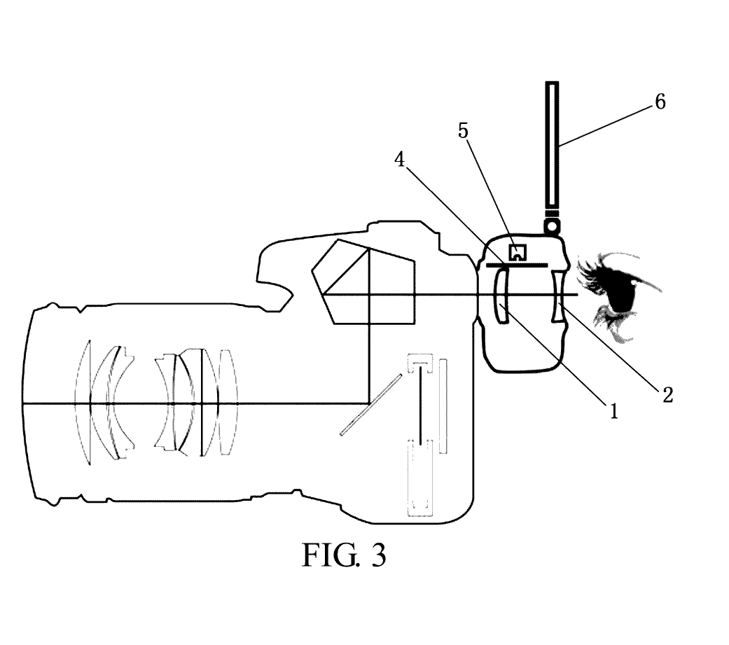

Refer to FIG. 1 and FIG. 2. FIG. 1 is the sectional drawing of the 1st embodiment of this invention under user mode 1. FIG. 2 is the sectional drawing of the 1st embodiment of this invention under user mode 2, in which the movable reflector 3 is used. Refer to FIG. 1. When the movable reflector 3 is not involved in view-finding and rests on one side of object lens 1 at a 45-degree position, with object lens 1 and eye lens 2 and SLR camera's lens assembly staying on the same optical axis, the external electronic viewfinder is used as an optical eye-level zoom-in viewfinder. Refer to FIG. 2. The viewfinder is used as an electronic one when object lens 1 and the attached movable reflector 3 move toward another side, with the former out of while the latter into the optical axis region of the lens assembly, to reflect the light from the optical viewfinder on miniature camera 5.

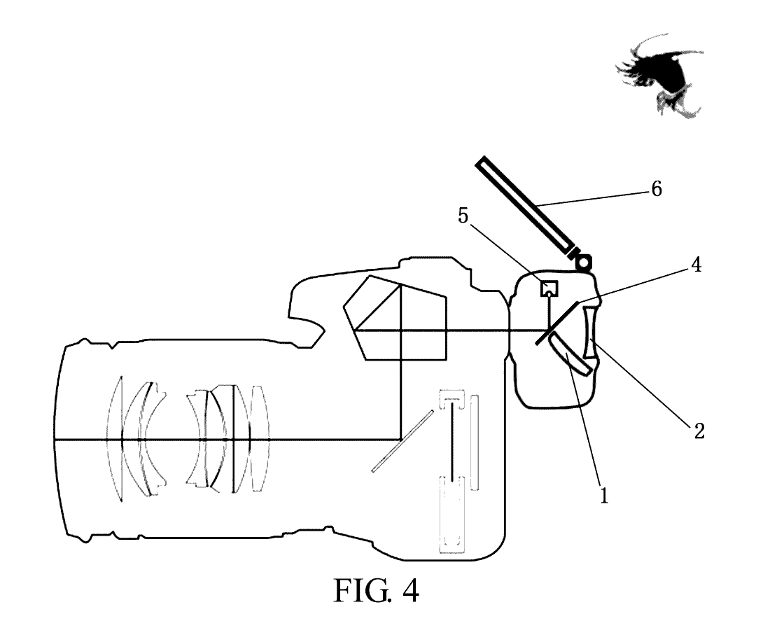

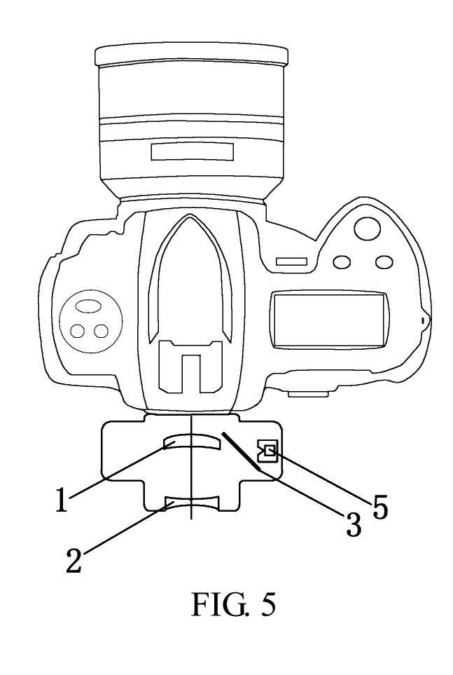

Refer to FIG. 3 and FIG. 4. FIG. 3 is the sectional drawing of the 2nd embodiment of this invention under user mode 1. FIG. 4 is the sectional drawing of the 2nd embodiment of this invention under user mode 2, in which rotating reflector 4 is used. Refer to FIG. 3. When rotating reflector 4 is on one side of object lens 1 parallel to its optical axis, with object lens 1, eye lens 2 and SLR camera's lens of optical viewfinder on the same optical axis, the external electronic viewfinder is used as an optical eye-level zoom-in viewfinder. Refer to FIG. 4. The viewfinder is used as an electronic viewfinder when object lens 1 and the attached rotating reflector 4 rotate 45 degrees on one side of the reflector, with the former out of and the latter into the optical axis region of the lens assembly, to reflect the light from the optical viewfinder on miniature camera 5

Refer to FIG. 1, FIG. 2, FIG. 3 and FIG. 4. The external electronic viewfinder is equipped with LCD 6, which is collapsible and rotatable. Miniature camera 5 sends images to LCD 6 so that the photographer can view and shoot by observing LCD 6.

To make electronic view-finding more convenient and incorporate remote capture, the miniature camera (5) of this electronic viewfinder sends images to external third-party display devices such as smart phone, flat panel display like a pad, or wearable display devices like Google Glass via wireless linkage. When the electronic viewfinder is connected with the mentioned display devices, the photographer can view and shoot by observing the display devices. Currently, the external electronic viewfinder integrates wireless receiver, shutter release and remote control. When the shutter release is linked to the SLR camera, shooting can be taken by the remote control.

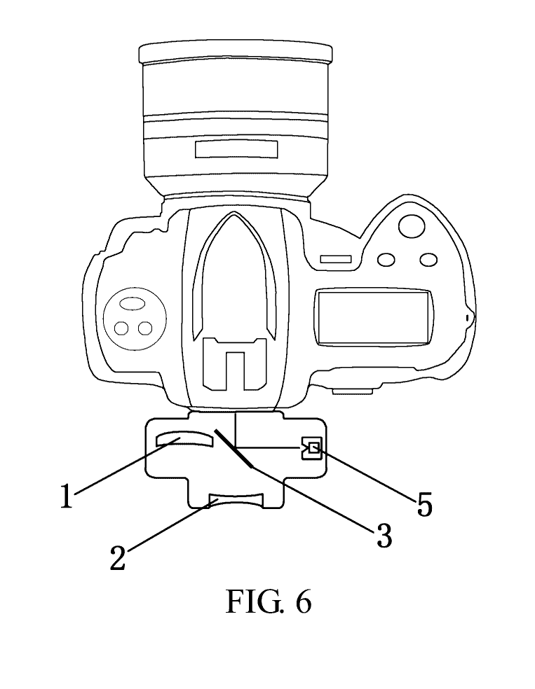

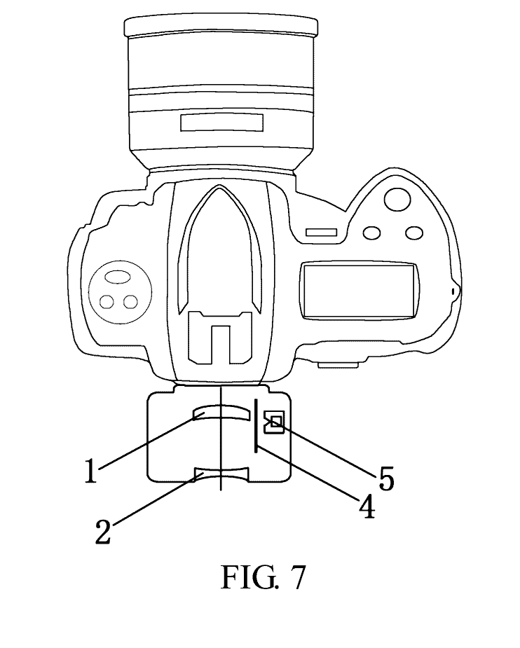

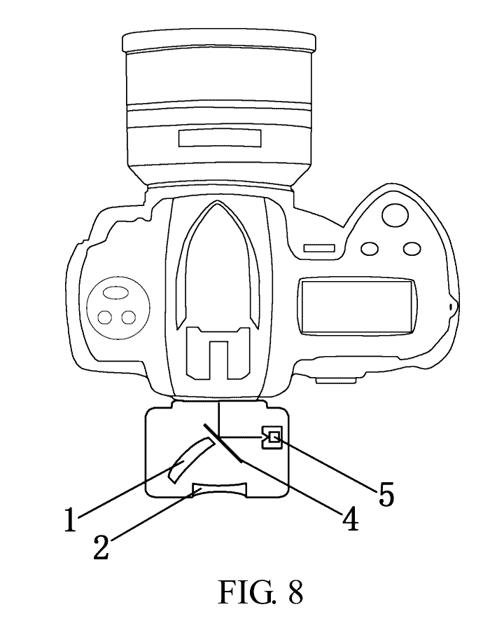

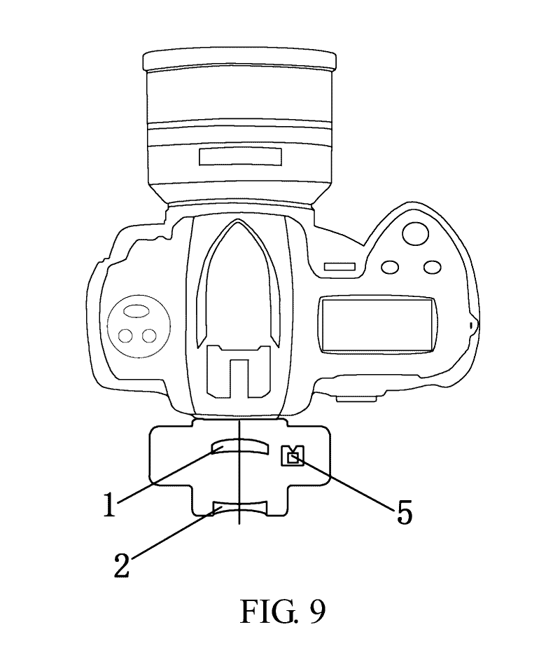

Refer to FIG. 5, FIG. 6, FIG. 7 and FIG. 8. FIG. 5 is the vertical view of the 3rd embodiment of this invention under user mode 1. FIG. 6 is the vertical view of the 3rd embodiment of this invention under user mode 2. FIG. 7 is the vertical view of the 4th embodiment of this invention under user mode 1. FIG. 8 is the vertical view of the 4th embodiment of this invention under user mode 2.

There is limited outboard space of the electronic viewfinder with flash above, built-in LCD beneath and keys on its right and left sides. To make full use of the available space, in reference to FIG. 5 and FIG. 6 of the 3rd embodiment, movable reflector 3 of this invention is designed to move horizontally. In reference to FIG. 7 and FIG. 8 of the 4th embodiment, rotating reflector 4 of this invention is designed to rotate 45 degrees horizontally.

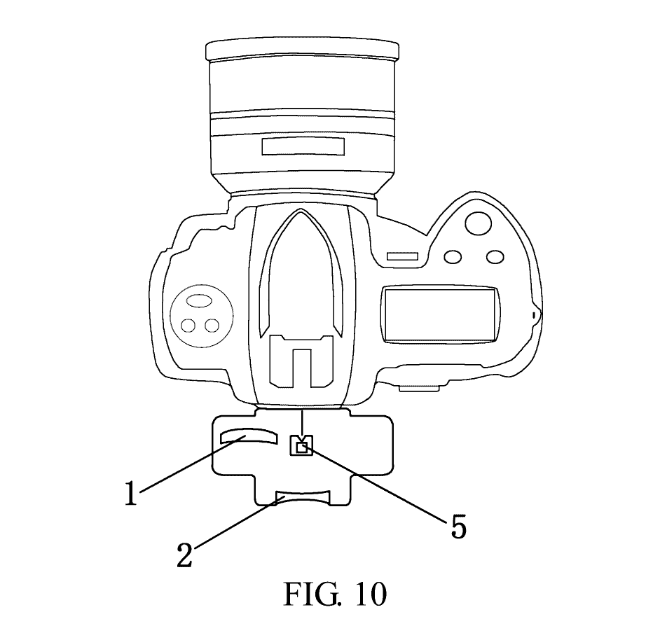

Refer to FIG. 9 and FIG. 10. FIG. 9 is the vertical view of the 5th embodiment of this invention under user mode 1. FIG. 10 is the vertical view of the 5th embodiment of this invention under user mode 2. Refer to FIG. 9 and FIG. 10. Some parts can be omitted in that embodiment. Movable reflector 3 or rotating reflector 4 can be removed and instead, miniature camera 5 is fixed on one side of object lens 1. The viewfinder consists of one or more pairs of lens assembly that is capable of zooming in the images of the optical viewfinder and a movable miniature camera 5. When miniature camera 5 is not involved in view-finding and rests on one side of the lens assembly, the viewfinder is used as an optical eye-level zoom-in viewfinder. When it is used as an electronic viewfinder, miniature camera 5 is moved to the optical axis of the eye-level zoom-in viewfinder and sends images to external display devices via wired or wireless linkage. Refer to FIG. 9. When movable miniature camera 5 is not involved in view-finding and rests on one side of the object lens 1, with object lens 1, eye lens 2 and lenses of the viewfinder on the same optical axis, the external electronic viewfinder is used as an optical eye-level zoom-in viewfinder. Refer to FIG. 10. The viewfinder is used as an electronic one when object lens 1 and the attached movable miniature camera 5 move toward another side, with the former out of and the latter into the optical axis region of the lens assembly. In this case, the miniature camera 5 can send images to external display devices via wired or wireless linkage.

To simplify the design and reduce costs, the movable reflector, rotating reflector or the movable miniature camera of the external electronic viewfinder can be moved or rotated with manual operation.

To improve the technological and automatic level and to make it handier and more user-friendly, the external electronic viewfinder can be equipped with a mini motor and a light sensor. When the photographer presses his eyes to the viewfinder, movable reflector 3, rotating reflector 4 or movable miniature camera 5 moves away from the optical axis region under the force of motor. The electronic viewfinder switches to an optical eye-level zoom-in viewfinder. When the eyes are off the viewfinder, movable reflector 3, rotating reflector 4 or movable miniature camera 5 enters the optical axis region under the force of the motor. The electronic viewfinder mode is ready and the LCD displays the images captured by the viewfinder.

Since the miniature camera, LCD, mini motor and light sensor live on power, the external electronic viewfinder shall have access to power supply, which can be a standard or rechargeable battery. To make the viewfinder smaller, the battery can be set on the back of the LCD.

The miniature camera in this invention displays images of fixed size, so it is advisable to use prime lens whose focal length is fixed. In addition, a lens allowing manual focus is an ideal option to meet the need of clearly presenting images on the focusing screen. A knob for manual focus is set on the viewfinder to form clear images from the focusing screen in case of automatic focusing causing image delay.

### INDUSTRY PRACTICABILITY

Sophisticated technologies are adopted in this invention, making it easy and economical to produce this viewfinder with practical functions through an innovative combination of several technologies. It has, to great extent, released the photographer's eyes, extended the SLR camera's range of application and made photographing more flexible and comfortable. This invention is utilitarian and is bound to invite revolutionary changes in photographing

1. An external electronic viewfinder for SLR camera, comprising: one or more pairs of lens assembly that is capable of zooming in the images from the optical viewfinder, a movable or rotating reflector, and a miniature camera; when the movable reflector or rotating reflector is not involved in view-finding and rests on one side of the lens assembly, the external electronic viewfinder is used as an optical eye-level zoom-in viewfinder, and when it is used as an electronic viewfinder, the movable reflector is moved or the rotating reflector is rotated to the optical axis region of the lens assembly so that the reflector reflects the light from the optical viewfinder to the miniature camera which sends images to external display devices via wired or wireless linkage.

2. The external electronic viewfinder for SLR described in claim 1, wherein the described lens assembly capable of zooming in the images of the optical viewfinder consists of an object lens (1) and an eye lens (2), the movable reflector (3), rotating reflector (4) or movable miniature camera (5) rests on one side of the object lens (1).

3. The external electronic viewfinder for SLR described in claim 2, wherein when the movable reflector (3) described rests on one side of the object lens (1) at a 45-degree position, with the object lens (1), eye lens (2) and the lens assembly of the optical viewfinder on the same optical axis, the external electronic viewfinder is used as an optical eye-level zoom-in viewfinder, and when it is used as an electronic viewfinder, the object lens (1) and the attached movable reflector (3) are moved toward another side, with the object lens (1) out of and the movable reflector (3) into the optical axis region of the lens assembly, to reflect the light from the optical viewfinder to the miniature camera (5).

4. The external electronic viewfinder for SLR described in claim 2, wherein when the movable reflector (4) described rests on one side of the object lens (1) parallel to its optical axis, with the object lens (1), eye lens (2) and the lens assembly on the same optical axis, the external electronic viewfinder is used as an optical eye-level zoom-in viewfinder, and when it is used as an electronic viewfinder, the object lens (1) and the attached rotating reflector (4) are rotated on one side of the rotating reflector (4), with the object lens (1) out of and rotating reflector (4) into the optical axis region of the lens assembly, to reflect the light from the optical viewfinder to the miniature camera (5).

5. The external electronic viewfinder for SLR described in claim 1, wherein the external electronic viewfinder described is equipped with a built-in LCD (6), a collapsible and rotatable one, to which the miniature camera (5) sends images via wired linkage and on which the photographer observes them.

6. The external electronic viewfinder for SLR described in claim 1, wherein images captured by miniature camera (5) can be sent to smart phone, flat panel display or wearable display devices via wireless linkage from the external electronic viewfinder.

7. The external electronic viewfinder for SLR described in claim 1, wherein the described movable reflector (3), rotating reflector (4) or movable miniature camera (5) can be moved or rotated with manual operation.

8. The external electronic viewfinder for SLR described in claim 1, wherein the external electronic viewfinder described is equipped with a mini motor and a light sensor; when the photographer presses his eyes to the viewfinder, the movable reflector (3), rotating reflector (4) or movable miniature camera (5) moves away from the optical axis region under the force of the motor, the electronic viewfinder switches to an optical eye-level zoom-in viewfinder, and when the eyes are off the viewfinder, the movable reflector (3), rotating reflector (4) or movable miniature camera (5) enters the optical axis region under the force of the motor, the electronic viewfinder mode is ready and the LCD (6) displays the images captured by the viewfinder.

9. The external electronic viewfinder for SLR described in claim 1, wherein the external electronic viewfinder described integrates wireless receiver and shutter release and remote control; when the shutter release is linked to the SLR camera, shooting can be taken by the remote control.

10. The external electronic viewfinder for SLR described in claim 1, wherein the miniature camera (5) described uses a prime lens allowing manual focus, a knob for manual focus is set on the viewfinder to form clear images from the focusing screen in case of automatic focusing causing image delay.

11. An external electronic viewfinder for SLR camera, comprising: a movable miniature camera and one or more pairs of lens assembly that is capable of zooming in the images of the optical viewfinder; when the movable miniature camera is not involved in view-finding and rests on one side of the lens assembly, the external electronic viewfinder is used as an optical eye-level zoom-in viewfinder, and when it is used as an electronic viewfinder, the miniature camera is moved to the optical axis so that the miniature camera sends images to external display devices via wired or wireless linkage.

12. The external electronic viewfinder for SLR described in claim 11, wherein the external electronic viewfinder described is equipped with a built-in LCD (6), a collapsible and rotatable one, to which the miniature camera (5) sends images via wired linkage and on which the photographer observes them.

13. The external electronic viewfinder for SLR described in claim 11, wherein images captured by miniature camera (5) can be sent to smart phone, flat panel display or wearable display devices via wireless linkage from the external electronic viewfinder.

14. The external electronic viewfinder for SLR described in claim 11, wherein the movable miniature camera (5) can be moved or rotated with manual operation.

15. The external electronic viewfinder for SLR described in claim 11, wherein the external electronic viewfinder described is equipped with a mini motor and a light sensor; when the photographer presses his eyes to the movable miniature camera (5) moves away from the optical axis region under the force of the motor, the electronic viewfinder switches to an optical eye-level zoom-in viewfinder, and when the eyes are off the viewfinder, the movable miniature camera (5) enters the optical axis region under the force of the motor, the electronic viewfinder mode is ready and the LCD (6) displays the images captured by the viewfinder.

16. The external electronic viewfinder for SLR described in claim 11, wherein the external electronic viewfinder described integrates wireless receiver and shutter release and remote control; when the shutter release is linked to the SLR camera, shooting can be taken by the remote control.

17. The external electronic viewfinder for SLR described in claim 11, wherein the miniature camera (5) described uses a prime lens allowing manual focus, a knob for manual focus is set on the viewfinder to form clear images from the focusing screen in case of automatic focusing causing image delay.
